(19) United States
(12) Patent Application Publication
(10) Pub. No.: US 2024/0393014 A1
(43) Pub. Date: Nov. 28, 2024

(54) WATER HEATER AND METHODS TO OPERATE A WATER HEATER

(71) Applicant: PITTWAY SARL, Rolle (CH)

(72) Inventors: Uwe Deptolla, Lotte (DE); Dusan Michalek, Brno (CZ)

(73) Assignee: PITTWAY SARL, Rolle (CH)

(21) Appl. No.: 18/694,082

(22) PCT Filed: Sep. 7, 2022
(86) PCT No.: PCT/EP2022/074784

§ 371 Date: Mar. 21, 2024

(30) Foreign Application Priority Data
Sep. 23, 2021 (EP) 21198629.4

(51) Int. Cl. F24H 9/16; F24D 17/00; F24H 8/00; F24H 9/00; F24H 15/32

(52) U.S. Cl. CPC F24H 9/16; F24D 17/0026; F24H 8/006; F24H 9/0042; F24H 15/32

(57) ABSTRACT

Water heater (10) comprising a gas burner (11) being configured to combust gas if a heat demand is present, namely if heated water is requested by at least one water consumer (24), further comprising a heat exchanger (17) being configured to heat water using the thermal energy provided with the combustion of the gas, wherein the heat exchanger is a condensing heat exchanger, further comprising an input pipe (18) being configured to provide water to be heated to the heat exchanger (17), further comprising an output pipe (19) being configured to provide water heated by the heat exchanger (17) to the at least one water consumer (24), further comprising a siphon or trap (22) being configured to collect condensate resulting at the condensing heat exchanger (17) during operation of the water heater (10), further comprising a first connection pipe (21) and a valve (23) acting together with the first connection pipe (21), both the first connection pipe (21) and the valve (23) being configured to guide a water heated by heat exchanger (17) from the output pipe (19) to the siphon or trap (22), and/or to guide water not heated by the heat exchanger (17) from the output pipe (19) to the siphon or trap (22).

The invention relates to a water heater. Further on, the invention relates to methods to operate a water heater.

EP 1 063 481 B1 discloses a water heater comprising a gas burner being configured to combust gas if a heat demand is present, further comprising a heat exchanger being configured to heat water using the thermal energy provided with the combustion of the gas, further comprising an input pipe being configured to provide water to be heated to the heat exchanger, further comprising an output pipe being configured to provide water heated by the heat exchanger to the at least one water consumer, and further comprising a connecting pipe, namely a bypass pipe, extending between the input pipe and the output pipe. The gas burner comprises a burner chamber in which the combustion of the gas takes place. The gas burner further comprises a gas armature providing the gas to be combusted to the burner chamber. Both, the burner chamber and the gas armature from part of the gas burner.

U.S. Pat. Nos. 4,922,861 A, 7,298,968 B1 and 10,883,743 B2 disclose other water heaters according to the prior art.

The gas burner of a water heater, especially the gas armature of the gas burner, needs to be calibrated from time to time. For performing a calibration of the gas burner, the gas burner needs to be operated at a defined calibration burner load for a defined calibration time interval. For water heaters according to the prior art, such a calibration of the gas burner can only be executed when a heat demand is present, namely if heated water is requested by at least one water consumer. Depending on the heat demand of the at least one water consumer, the operation of the gas burner at the defined calibration burner load for the defined calibration time interval can lead to a water temperature at the respective water consumer being either too high or too low. This is a significant disadvantage of water heaters known from prior art.

Against this background, a novel water heater and methods to operate such a water heater are provided.

The invention provides a water heater according to claim 1.

The water heater comprises a gas burner being configured to combust gas if a heat demand is present, namely if heated water is requested by at least one water consumer. The water heater further comprises a heat exchanger being configured to heat water using the thermal energy provided with the combustion of the gas, wherein the heat exchanger is a condensing heat exchanger.

The water heater further comprises an input pipe being configured to provide water to be heated to the heat exchanger.

The water heater further comprises an output pipe being configured to provide water heated by the heat exchanger to the at least one water consumer.

The water heater further comprises a siphon or trap being configured to collect condensate resulting at the condensing heat exchanger during operation of the water heater.

The water heater further comprises a first connection pipe and a valve acting together with the first connection pipe, both the first connection pipe and the valve are configured to guide water heated by heat exchanger from the output pipe to the siphon or trap, and/or to guide water not heated by the heat exchanger from the output pipe to the siphon or trap.

The novel water heater can be operated with the gas burner combusting gas even if there is no heat demand by a water consumer.

Calibrations of the water heater can be executed even if there is no heat demand by a water consumer. The water heated by the water heater during such a calibration can be guided to the siphon or trap.

According to a first embodiment, the valve acting together with the first connection pipe is a 2-way valve positioned within the first connection pipe, wherein a first port of the 2-way valve is connected to the output pipe through a first section of the first connecting pipe, and wherein a second port of the 2-way valve is connected to the siphon or trap through a second section of the first connecting pipe. Both, water heated by heat exchanger and water not heated by the heat exchanger can be guided from the output pipe to the siphon or trap through the first connection pipe and the valve acting together with the first connection pipe.

According to a second embodiment, the valve acting together with the first connection pipe is a 3-way valve, wherein a first port of the 3-way-valve is connected to the heat exchanger through a first section of the output pipe, wherein a second port of the 3-way-valve is connected to the at least one water consumer through a second section of the output pipe, and wherein a third port of the 3-way-valve is connected to the siphon or trap through the first connecting pipe. Both, water heated by heat exchanger and water not heated by the heat exchanger can be guided from the output pipe to the siphon or trap through the first connection pipe and the valve acting together with the first connection pipe.

In both the first embodiment and the second embodiment the water heater may comprise a second connecting pipe extending between the input pipe and the output pipe, and may further comprise a separate valve acting together with the second connection pipe being configured to guide water from input pipe to the output pipe.

According to a third embodiment, the second connecting pipe extending between the input pipe and the output pipe is mandatory, wherein the first connecting pipe extends between the second connecting pipe and the siphon or trap. The valve acting together with the first connection pipe is provided by a 3-way-valve connected between the first connecting pipe and the second connecting pipe. Said valve acts also together with the second connection pipe, wherein a first port of the 3-way-valve is connected to the output pipe through a first section of the second connecting pipe, wherein a second port of the 3-way-valve is connected to the input pipe through a second section of the second connecting pipe, and wherein a third port of the 3-way-valve is connected to the siphon or trap through the first connecting pipe. Both, water heated by heat exchanger and water not heated by the heat exchanger can be guided from the output pipe to the siphon or trap through the first connection pipe and the valve acting together with the first connection pipe.

Further on, the invention provides methods to operate a water heater according to claims 7, 9, 11, 13 and 14.

Preferred developments of the invention are provided by the dependent claims and the description which follows. Exemplary embodiments are explained in more detail on the basis of the drawing, in which:

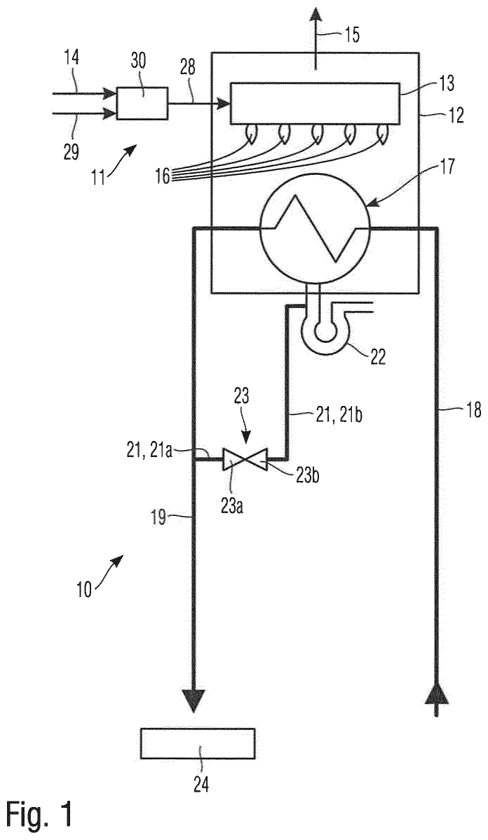

FIG. 1 shows a first water heater according to the present invention,

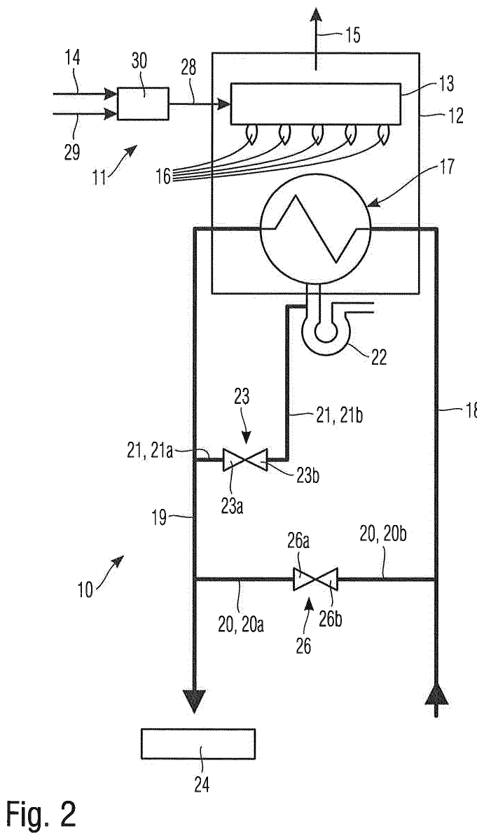

FIG. 2 shows a second water heater according to the present invention,

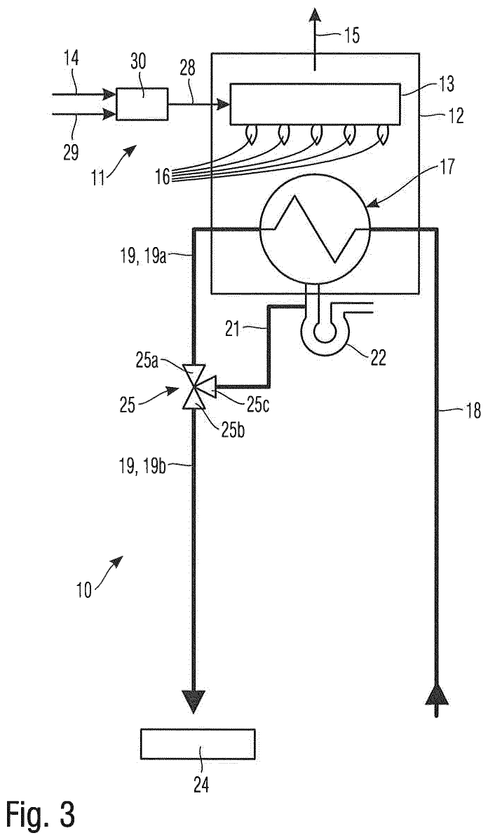

FIG. 3 shows a third water heater according to the present invention,

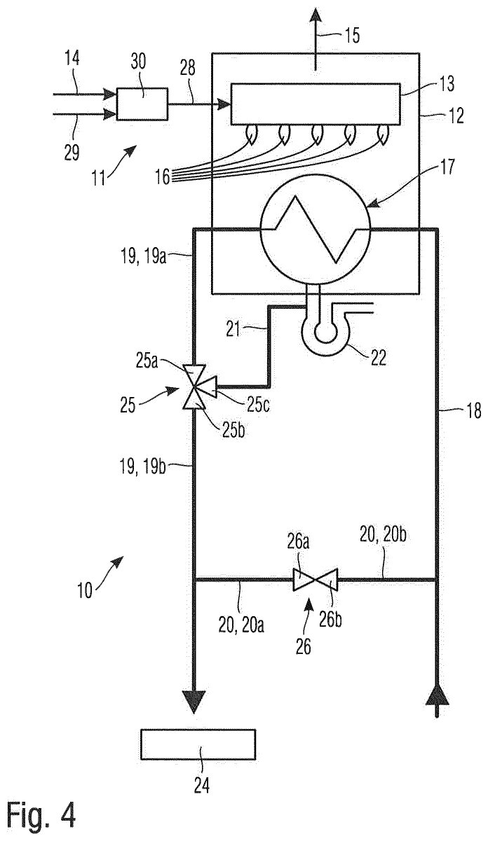

FIG. 4 shows a fourth water heater according to the present invention,

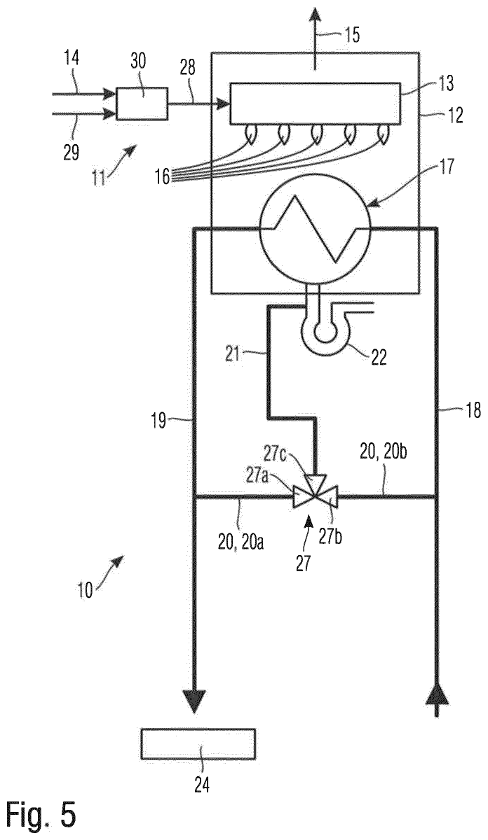

FIG. 5 shows a fifth water heater according to the present invention.

FIGS. 1 and 2 each show a water heater 10 according to a first embodiment of the present invention.

The water heater 10 according to the present invention comprises a gas burner 11 being configured to combust a gas if a heat demand is present, namely if heated water is requested by at least one water consumer 24.

The gas burner comprises 11 a burner chamber 12. A burner rod 13 of the gas burner 11 is positioned within the burner chamber 11.

Gas 14 is provided to the burner rod 13 for combusting the gas 14 within the burner chamber 12. The gas 14 is preferably provided as a gas/air mixture 28. The combustion of the gas 14 of gas/air mixture 28 results into flames 16 and exhaust gas 15. The exhaust gas 15 emerges from the burner chamber 12 through a chimney.

As mentioned above, the gas 14 is preferably provided as a gas/air mixture 28. Such a gas/air mixture 28 is usually provided by a gas armature 30 of the gas burner 11. Such gas armatures 30 are well known. Such a gas armature 30 usually comprises a fan (not shown) proving a flow of air 29, a gas valve or gas modulator (not shown) providing a flow of the gas 14 and a mixing unit (not shown) mixing the air flow with the gas flow. The mixing ratio of gas 14 and air 29 within the gas/air mixture 28 is usually kept at a defined value over the entire modulation rage of the gas burner 11 such that at any burner load of the gas burner 11 the mixing ratio of the gas/air mixture 28 is kept at the defined value.

The water heater 10 further comprises a heat exchanger 17 being configured to heat water using the thermal energy provided with the combustion of the gas 14. The heat exchanger 17 is positioned inside the burner chamber 12. The heat exchanger 17 is a condensing heat exchanger.

The water heater 10 further comprises an input pipe 18 being configured to provide unheated water, namely water to be heated by the heat exchanger 17, to the heat exchanger 17. The water heater 10 further comprises an output pipe 19 being configured to provide water heated by the heat exchanger 17 to the at least one water consumer 24. The water heater 10 further comprises a siphon or trap 22 being configured to collect condensate resulting at the condensing heat exchanger 17 during operation of the water heater 10.

The water heater 10 further comprises a first connecting pipe 21 and a valve 23 acting together with the first connection pipe 21. Both the first connection pipe 21 and the valve 23 are configured to guide water heated by heat exchanger 17 from the output pipe 19 to the siphon or trap 22, and to guide water not heated by the heat exchanger 17 from the output pipe 19 to the siphon or trap 22.

In FIGS. 1 and 2, the first connection pipe 21 extends between the output pipe 19 and the siphon or trap 22. The valve 23 acting together with the first connection pipe 21 is a 2-way valve positioned within the first connection pipe 21, wherein a first port 23a of the 2-way valve is connected to the output pipe 19 through a first section 21a of the first connecting pipe 21, and wherein a second port 23b of the 2-way valve is connected to the siphon or trap 22 through a second section 21b of the first connecting pipe 21. FIG. 2 shows a modification of water heater 10 of FIG. 1. In FIG. 2 the water heater 10 comprises further a second connecting pipe 20 extending between the input pipe 18 and the output pipe 19, and a separate valve 26 acting together with the second connection pipe 20 being configured to guide water from input pipe 18 to the output pipe 19. A first section 20a of the second connecting pipe 20 extends between the output pipe 19 and the separate valve 26. A second section 20a of the second connecting pipe 20 extends between the input pipe 18 and the separate valve 26. All other details of the water heater of FIG. 2 are identical to the water heater of FIG. 1. The second connecting pipe may also be called bypass pipe.

If a heat demand is present at the water heater 10 of FIGS. 1 and 2, namely if heated water is requested by the at least one water consumer 24, the input pipe 18 provides water to the heat exchanger 17, said water becomes heated by the heat exchanger 17 when flowing through the same using the thermal energy resulting from the combustion of the gas 14 by the gas burner 11, and the water heated by the heat exchanger 17 is provided to the respective water consumer 24. In this situation the valve 23 is closed. In FIG. 2 the valve 26 may be opened or closed in this situation. If the valve 26 is closed in this situation, only water heated by the heat exchanger 17 is provided to the respective water consumer 24. If the valve 26 is opened in this situation, the water heated by the heat exchanger 17 becomes mixed with unheated water bypassing the heat exchanger 17 and said mixture is provided to the respective water consumer 24. If a heat demand is not present at the water heater 10 of FIGS. 1 and 2, namely if heated water is not requested by the at least one water consumer 24, the gas burner 11 may be active and may combust gas 14 or may inactive and may not combust gas 14.

If a heat demand is not present and if the gas burner 11 of the water heater 10 of FIGS. 1 and 2 is combusting gas 14, water heated by the heat exchanger 17 can be provided to the siphon or trap 22 from the output pipe 19 through the first connecting pipe 21 and through the valve 23.

If a heat demand is not present and if the gas burner 11 of the water heater 10 of FIGS. 1 and 2 is not combusting gas 14, water not being heated by the heat exchanger 17 but flowing through the same can be provided to the siphon or trap 22 from the output pipe 19 through the first connecting pipe 21 and through the valve 23.

So, heated water as well as unheated water can be provided to the siphon or trap without any water consumption at a water consumer 24.

If no heat demand is present, namely if heated water is not requested by the at least one water consumer 24, for a calibration of the gas burner 11 of the water heater 10 of FIGS. 1 and 2, the water heater 10 is operated as follows: The gas burner 11 is operated at a defined calibration burner load for a defined calibration time interval and the water heated by the heat exchanger 17 during the calibration is provided by the valve 23 to the siphon or trap 22. During the calibration, the heated water is provided by the valve 23 to the siphon or trap 22 from the output pipe 19, namely in such a way that the heated water flows from the output pipe 19 through the first section 21a of the first connecting pipe 21, through the valve 23 and through the second section 21b of the first connecting pipe 21 to the siphon or trap 22.

If no heat demand is present, namely if heated water is not requested by the at least one water consumer 24, for a filling the siphon or trap 22 directly after installation of the water heater 10 of FIGS. 1 and 2, the water heater 10 is operated as follows: Unheated water or heated water is provided by the valve 23 to the siphon or trap 22. Preferably, the unheated water or the heated water is provided by the valve 23 to the siphon or trap 22 from the output pipe 19.

To provide heated water to the siphon or trap 22, the gas burner 11 is combusting gas 14 at a defined burner load. To provide unheated water to the siphon or trap 22, the gas burner 11 is not combusting gas 14. The heated water or the unheated water is provided by the valve 23 to the siphon or trap 22 from the output pipe 19, namely in such a way that the water flows from the output pipe 19 through the first section 21a of the first connecting pipe 21, through the valve 23 and through the second section 21b of the first connecting pipe 21 to the siphon or trap 22.

If no heat demand is present, namely if heated water is not requested by the at least one water consumer 24, for a cleaning the siphon or trap 22 the water heater of FIGS. 1 and 2 is operated as follows: Unheated water or heated water is provided by the valve 23 to the siphon or trap 22. Unheated water or heated water is provided by the valve 23 to the siphon or trap 22. Preferably, the unheated water or the heated water is provided by the valve 23 to the siphon or trap 22 from the output pipe 19.

To provide heated water to the siphon or trap 22, the gas burner 11 is combusting gas 14 at a defined burner load. To provide unheated water to the siphon or trap 22, the gas burner 11 is not combusting gas 14. The heated water or the unheated water is provided by the valve 23 to the siphon or trap 22 from the output pipe 19, namely in such a way that the water flows from the output pipe 19 through the first section 21a of the first connecting pipe 21, through the valve 23 and through the second section 21b of the first connecting pipe 21 to the siphon or trap 22.

If no heat demand is present, namely if heated water is not requested by the at least one water consumer 24, for a descaling of the heat exchanger 17 the water heater 10 of FIGS. 1 and 2 is operated as follows. The following steps i) and ii) are alternately executed. Step i): Combust gas with the gas burner 11 at a defined burner load for a defined first time interval and provide the heated water to the siphon or trap 22. Step ii): Stop combustion of gas within the gas burner 11 for a defined second time interval and provide the unheated water to the siphon or trap 22.

If no heat demand is present, namely if heated water is not requested by the at least one water consumer 24, for a descaling of the heat exchanger 17 the water heater 10 of FIGS. 1 and 2 is alternatively operated as follows. The following steps i) and ii) are alternately executed. Step i): Combust gas with the gas burner 11 at a defined first burner load for a defined first time interval and provide the heated water to the siphon or trap 22. Step ii) combust gas with the gas burner 11 at a defined second burner load for a defined second time interval and provide the heated water to the siphon or trap 22, wherein the first burner load is relatively low compared to the second burner load. The first burner load may be a minimum burner load and the second burner load may be a maximum burner load.

For the descaling of the heat exchanger 17 of the water heater 10, during the first time interval and during the second time interval the water is provided from the output pipe 19 to the siphon or trap 22 through the valve 23, namely in such a way that the water flows from the output pipe 19 through the first section 21a of the first connecting pipe 21, through the valve 23 and through the second section 21b of the first connecting pipe 21 to the siphon or trap 22.

If in FIGS. 1 and 2 water flows from output pipe 19 to the siphon or trap 22, the valve 23 is opened.

FIGS. 3 and 4 both show a water heater 10 according to a second embodiment of the present invention. The water heater of FIG. 3 differs from the water heater of FIG. 1 and the water heater of FIG. 4 differs from the water heater of FIG. 2 merely by the design of the respective valve 23, 25 acting together with first connection pipe 21. While in FIGS. 1 and 2 said valve 23 is provided by a 2-way valve, in FIGS. 3 and 4 said valve 25 is provided by a 3-way-valve. In FIGS. 3 and 4, a first port 25a of the 3-way-valve is connected to the heat exchanger 17 through a first section 19a of the output pipe 19, wherein a second port 25b of the 3-way-valve is connected to the at least one water consumer 24 through a second section 19b of the output pipe 19, and wherein a third port 25c of the 3-way-valve is connected to the siphon or trap 22 through the first connecting pipe 21. FIG. 4 differs from FIG. 3 merely by the second connecting pipe 20 extending between the input pipe 18 and the output pipe 19, and by the separate valve 26 acting together with second connection pipe 20 being configured to guide water from input pipe 18 to the output pipe 19.

In FIGS. 3 and 4 as well as in FIGS. 1 and 2 both the first connection pipe 21 and the respective valve 23, 25 are configured to guide water heated by heat exchanger 17 from the output pipe 19 to the siphon or trap 22, and to guide water not heated by the heat exchanger 17 from the output pipe 19 to the siphon or trap 22. The second connecting pipe 20 may also be called bypass pipe.

If a heat demand is present at the water heater 10 of FIGS. 3 and 4, namely if heated water is requested by the at least one water consumer 24, the input pipe 18 provides water to the heat exchanger 17, said water becomes heated by the heat exchanger 17 when flowing through the same using the thermal energy resulting from the combustion of the gas 14 by the gas burner 11, and the water heated by the heat exchanger 17 is provided to the respective water consumer 24. In this situation the ports 25a, 25b of the valve 25 are opened and the port 25c of the valve is closed. In FIG. 4 the valve 26 may be opened or closed in this situation. If the valve 26 is closed in this situation, only water heated by the heat exchanger 17 is provided to the respective water consumer 24. If the valve 26 is opened in this situation, the water heated by the heat exchanger 17 becomes mixed with unheated water bypassing the heat exchanger 17 and said mixture is provided to the respective water consumer 24. If a heat demand is not present at the water heater 10 of FIGS. 3 and 4, namely if heated water is not requested by the at least one water consumer 24, the gas burner 11 may be active and may combust gas 14 or may inactive and may not combust gas 14.

If a heat demand is not present and if the gas burner 11 of the water heater 10 of FIGS. 3 and 4 is combusting gas 14, water heated by the heat exchanger 17 can be provided to the siphon or trap 22 from the output pipe 19 through the first connecting pipe 21 and through the valve 25.

If a heat demand is not present and if the gas burner 11 of the water heater 10 of FIGS. 3 and 4 is not combusting gas 14, water not being heated by the heat exchanger 17 but flowing through the same can be provided to the siphon or trap 22 from the output pipe 19 through the first connecting pipe 21 and through the valve 25. So, heated water as well as unheated water can be provided to the siphon or trap 22 without any water consumption at a water consumer 24.

If no heat demand is present, namely if heated water is not requested by the at least one water consumer 24, for a calibration of the gas burner 11 of the water heater 10 of FIGS. 3 and 4, the water heater 10 is operated as follows: The gas burner 11 is operated at a defined calibration burner load for a defined calibration time interval and the water heated by the heat exchanger 17 during the calibration is provided by the valve 25 to the siphon or trap 22. In this situation the ports 25a, 25c of the valve 25 are opened and the port 25b of the valve 25 is closed. During the calibration, the heated water is provided by the valve 25 to the siphon or trap 22 from the output pipe 19, namely in such a way that the heated water flows from the first section 19a of the output pipe 19 through the valve 25 and through the first connecting pipe 21 to the siphon or trap 22.

If no heat demand is present, namely if heated water is not requested by the at least one water consumer 24, for a filling the siphon or trap 22 directly after installation of the water heater 10 of FIGS. 3 and 4, the water heater 10 is operated as follows: Unheated water or heated water is provided by the valve 25 to the siphon or trap 22. Preferably, the unheated water or the heated water is provided by the valve 25 to the siphon or trap 22 from the output pipe 19. To provide heated water to the siphon or trap 22, the gas burner 11 is combusting gas 14 at a defined burner load. To provide unheated water to the siphon or trap 22, the gas burner 11 is not combusting gas 14. The heated water or the unheated water is provided by the valve 25 to the siphon or trap 22 from the output pipe 19, namely in such a way that the water flows from the first section 19a of the output pipe 19 through the valve 25 and through the first connecting pipe 21 to the siphon or trap 22.

If no heat demand is present, namely if heated water is not requested by the at least one water consumer 24, for a cleaning the siphon or trap 22 the water heater of FIGS. 3 and 4 is operated as follows: Unheated water or heated water is provided by the valve 25 to the siphon or trap 22. Unheated water or heated water is provided by the valve 25 to the siphon or trap 22. Preferably, the unheated water or the heated water is provided by the valve 25 to the siphon or trap 22 from the output pipe 19. To provide heated water to the siphon or trap 22, the gas burner 11 is combusting gas 14 at a defined burner load. To provide unheated water to the siphon or trap 22, the gas burner 11 is not combusting gas 14. The heated water or the unheated water is provided by the valve 25 to the siphon or trap 22 from the output pipe 19, namely in such a way that the water flows from the first section 19a of the output pipe 19 through the valve 25 and through the first connecting pipe 21 to the siphon or trap 22.

If no heat demand is present, namely if heated water is not requested by the at least one water consumer 24, for a descaling of the heat exchanger 17 the water heater 10 of FIGS. 3 and 4 is operated as follows. The following steps i) and ii) are alternately executed. Step i): Combust gas with the gas burner 11 at a defined burner load for a defined first time interval and provide the heated water to the siphon or trap 22. Step ii): Stop combustion of gas within the gas burner 11 for a defined second time interval and provide the unheated water to the siphon or trap 22.

If no heat demand is present, namely if heated water is not requested by the at least one water consumer 24, for a descaling of the heat exchanger 17 the water heater 10 of FIGS. 3 and 4 is alternatively operated as follows. The following steps i) and ii) are alternately executed. Step i): Combust gas with the gas burner at a defined first burner load for a defined first time interval and provide the heated water to the siphon or trap 22. Step ii) combust gas with the gas burner 11 at a defined second burner load for a defined second time interval and provide the heated water to the siphon or trap 22, wherein the first burner load is relatively low compared to the second burner load. The first burner load may be a minimum burner load and the second burner load may be a maximum burner load.

For the descaling of the heat exchanger 17 of the water heater 10, during the first time interval and during the second time interval the water is provided from the output pipe 19 to the siphon or trap 22 through the valve 25, namely in such a way that the water flows from the first section 19a of the output pipe 19 through the valve 25 and through the first connecting pipe 21 to the siphon or trap 22.

If in FIGS. 3 and 4 water flows from output pipe 19 to the siphon or trap 22, the ports 25a, 25c of the valve 25 are opened and the port 25b of the valve 25 is closed.

FIG. 5 both shows a water heater 10 according to a third embodiment of the present invention.

The water heater 10 of FIG. 5 mandatorily comprises the second connecting pipe extending between the input pipe 18 and the output pipe 19. The second connecting pipe 20 may also be called bypass pipe. In FIG. 5, the first connecting pipe 21 extends between the second connecting pipe 20 and the siphon or trap 22.

The water heater of FIG. 5 further comprises a valve 27 connected between the first connecting pipe 21 and the second connecting pipe 22. Said valve 27 is configured to guide water heated by heat exchanger 17 from the output pipe 19 to the siphon or trap 22, and to guide water unheated by the heat exchanger 17 but flowing through the same from the output pipe 19 to the siphon or trap 22. This can be done even if no heat demand is present, namely if heated water is not requested by the at least one water consumer 24. Said valve 27 is also configured to guide unheated water bypassing the heat exchanger 18 from the input pipe 18 to the siphon or trap 22.

The valve 27 of FIG. 5 is a 3-way-valve. A first port 27a of the 3-way-valve 27 is connected to output pipe 19 through a first section 20a of the second connecting pipe 20. A second port 27b of the 3-way-valve 27 is connected to input pipe 18 through a second section 20b of the second connecting pipe 20. A third port 27c of the 3-way-valve 27 is connected to the siphon or trap 22 through the first connecting pipe 21.

If a heat demand is present at the water heater of FIG. 5, namely if heated water is requested by the at least one water consumer 24, the input pipe 18 provides water to the heat exchanger 17, said water becomes heated by the heat exchanger 17 when flowing through the same using the thermal energy resulting from the combustion of the gas 14 by the gas burner 11, and the water heated by the heat exchanger 17 is provided to the respective water consumer 24. In this situation the valve 27 may be closed or opened.

If the valve 27 is closed in this situation, only water heated by the heat exchanger is provided to the respective water consumer 24. If the valve 27 is opened in this situation, the water heated by the heat exchanger 17 becomes mixed with unheated water bypassing the heat exchanger and said mixture is provided to the respective water consumer 24.

If a heat demand is not present at the water heater of FIG. 5, namely if heated water is not requested by the at least one water consumer 24, the gas burner 11 may be active and may combust gas 14 or may inactive and may not combust gas 14.

If a heat demand is not present and if the gas burner 11 of the water heater of FIG. 5 is combusting gas 14, water heated by the heat exchanger 17 can be provided to the siphon or trap 22 from the output pipe 19 through the first section 20a of first connecting pipe 20, through the 3-way valve 27 and through the second connecting pipe 21.

If a heat demand is not present and if the gas burner 11 of the water heater of FIG. 5 is not combusting gas 14, water not being heated by the heat exchanger 17 but flowing through the same can be provided to the siphon or trap 22 from the output pipe 19 through the first section 20a of first connecting pipe 20, through the 3-way valve 27 and through the second connecting pipe 21.

So, heated water as well as unheated water can be provided to the siphon or trap without any water consumption at a water consumer 24.

If no heat demand is present, namely if heated water is not requested by the at least one water consumer 24, for a calibration of the gas burner 11 of the water heater 10 of FIG. 5 the water heater 10 is operated as follows: The gas burner 11 is operated at a defined calibration burner load for a defined calibration time interval and the water heated by the heat exchanger 17 during the calibration is provided by the valve 27 to the siphon or trap 22. During the calibration, the heated water is provided by the valve 27 to the siphon or trap 22 from the output pipe 19, namely in such a way that the heater water flows from the output pipe 19 through the first section 20a of the first connecting pipe 20, through the valve 27 and through the second connection pipe 21 to the siphon or trap 22.

If no heat demand is present, namely if heated water is not requested by the at least one water consumer 24, for a filling the siphon or trap 22 directly after installation of the water heater 10 of FIG. 5, the water heater 10 is operated as follows: Unheated water or heated water is provided by the valve 27 to the siphon or trap 22. Preferably, the unheated water or the heated water is provided by the valve 27 to the siphon or trap 22 from the output pipe 19. To provide heated water to the siphon or trap 22, the gas burner 11 is combusting gas 14 at a defined burner load. To provide unheated water to the siphon or trap 22, the gas burner 11 is not combusting gas 14. The heated water or the unheated water is provided by the valve 27 to the siphon or trap 22 from the output pipe 19, namely in such a way that the water flows from the output pipe 19 through the first section 20a of the first connecting pipe 20, through the valve 27 and through the second connection pipe 21 to the siphon or trap 22.

If no heat demand is present, namely if heated water is not requested by the at least one water consumer 24, for a cleaning the siphon or trap 22 the water heater of FIG. 5 is operated as follows: Unheated water or heated water is provided by the valve to the siphon or trap 22. Unheated water or heated water is provided by the valve 27 to the siphon or trap 22. Preferably, the unheated water or the heated water is provided by the valve 27 to the siphon or trap 22 from the output pipe 19. To provide heated water to the siphon or trap 22, the gas burner 11 is combusting gas 14 at a defined burner load. To provide unheated water to the siphon or trap 22, the gas burner 11 is not combusting gas 14. The heated water or the unheated water is provided by the valve 27 to the siphon or trap 22 from the output pipe 19, namely in such a way that the water flows from the output pipe 19 through the first section 20a of the first connecting pipe 20, through the valve 27 and through the second connection pipe 21 to the siphon or trap 22.

If no heat demand is present, namely if heated water is not requested by the at least one water consumer 24, for a descaling of the heat exchanger 17 the water heater 10 of FIG. 5 is operated as follows. The following steps i) and ii) are alternately executed. Step i): Combust gas with the gas burner 11 at a defined burner load for a defined first time interval and provide the heated water to the siphon or trap 22. Step ii): Stop combustion of gas within the gas burner 11 for a defined second time interval and provide the unheated water to the siphon or trap 22.

If no heat demand is present, namely if heated water is not re-quested by the at least one water consumer 24, for a descaling of the heat exchanger 17 the water heater 10 of FIG. 5 is alternatively operated as follows. The following steps i) and ii) are alternately executed. Step i): Combust gas with the gas burner 11 at a defined first burner load for a defined first time interval and provide the heated water to the siphon or trap 22. Step ii) combust gas with the gas burner 11 at a defined second burner load for a defined second time interval and provide the heated water to the siphon or trap 22, wherein the first burner load is relatively low compared to the second burner load. The first burner load may be a minimum burner load and the second burner load may be a maximum burner load.

For the descaling of the heat exchanger 17 of the water heater 10 of FIG. 5, during the first time interval and during the second time interval the water is provided from the output pipe 19 to the siphon or trap 22 through the valve 27, namely in such a way that the water flows from the output pipe 19 through the first section 20a of the first connecting pipe 20, through the valve 27 and through the second connection pipe 21 to the siphon or trap 22.

If in FIG. 5 water flows from output pipe 19 through the first section 20a of the first connecting pipe 20, through the valve 27 and through the second connection pipe 21 to the siphon or trap 22, the valve 27 is in a status in which the first valve port 27a and third valve port valve 27c are unblocked or opened while the second valve port 27b is blocked or closed.

### LIST OF REFERENCE SIGNS

water heater
gas burner
combustion camber
burner rod
gas or gas/air mixture
exhaust gas
flame
heat exchanger
input pipe
output pipe
19a first section
19b second section
connecting pipe
20a first section
20b second section
connecting pipe
21a first section
21b second section
siphon or trap
valve
23a first valve port
23b second valve port
water consumer
valve
25a first valve port
25b second valve port
25c third valve port
valve
26a first valve port
26b second valve port
valve
27a first valve port
27b second valve port
27c third valve port
gas/air mixture
air
gas armature

1. A water heater comprising:
a gas burner being configured to combust gas if a heat demand is present, namely if heated water is requested by at least one water consumer,
a heat exchanger being configured to heat water using thermal energy provided with the combustion of the gas, wherein the heat exchanger is a condensing heat exchanger,
an input pipe being configured to provide water to be heated to the heat exchanger,
an output pipe being configured to provide water heated by the heat exchanger to the at least one water consumer,
a siphon or trap being configured to collect condensate resulting at the condensing heat exchanger during operation of the water heater,
a first connection pipe and a valve acting together with the first connection pipe, both the first connection pipe and the valve (23, 25, 27) being configured to:
guide water heated by heat exchanger from the output pipe to the siphon or trap, and/or
guide water not heated by the heat exchanger from the output pipe to the siphon or trap.

2. The water heater of claim 1,
wherein the valve acting together with first connection pipe is a 2-way valve positioned within the first connection pipe,
wherein a first port of the 2-way valve is connected to the output pipe through a first section of the first connecting pipe,
wherein a second port of the 2-way valve is connected to the siphon or trap through a second section of the first connecting pipe.

3. The water heater of claim 1, wherein the valve acting together with first connection pipe is a 3-way valve,
wherein a first port of the 3-way valve is connected to the heat exchanger through a first section of the output pipe,
wherein a second port of the 3-way valve is connected to the at least one water consumer through a second section of the output pipe,
wherein a third port of the 3-way valve is connected to the siphon or trap through the first connecting pipe.

4. The water heater of claim 1,
wherein a second connecting pipe extending between the input pipe and the output pipe,
wherein a separate valve acting together with the second connection pipe being configured to guide water from input pipe to the output pipe.

5. The water heater of claim 1,
wherein a second connecting pipe extending between the input pipe and the output pipe, wherein the first connecting pipe extends between the second connecting pipe and the siphon or trap,
the valve acting together with the first connection pipe is provided by a 3-way valve, is connected between the first connecting pipe and the second connecting pipe and acts also together with the second connection pipe,
wherein a first port of the 3-way valve is connected to the output pipe through a first section of the second connecting pipe,
wherein a second port of the 3-way valve is connected to the input pipe through a second section of the second connecting pipe, and
wherein a third port of the 3-way valve is connected to the siphon or trap through the first connecting pipe.

6. The water heater of claim 1, wherein:
the gas burner comprises a burner chamber,
the heat exchanger is positioned inside the burner chamber of the gas burner,
the siphon or trap is positioned outside of the burner chamber of the gas burner.

7. A method to operate the water heater of claim 1,
wherein if no heat demand is present, namely if heated water is not requested by the at least one water consumer, for a calibration of the gas burner of the water heater the gas burner is operated at a defined burner load for a defined time interval and the water heated by the heat exchanger during the calibration is provided to the siphon or trap.

8. The method of claim 7,
wherein the water heated during the calibration is provided from the output pipe to the siphon or trap through the valve.

9. The method of claim 7,
wherein if no heat demand is present, namely if heated water is not requested by the at least one water consumer, for a filling of the siphon or trap directly after installation of the water heater unheated water or heated water is provided to the siphon or trap.

10. The method of claim 9,
wherein the unheated water or the heated water is provided from the output pipe to the siphon or trap through the valve.

11. The method claim 10,
wherein if no heat demand is present, namely if heated water is not requested by the at least one water consumer, for a cleaning of the siphon or trap unheated water or heated water is provided to the siphon or trap.

12. The method of claim 11,
wherein the unheated water or the heated water is provided from the output pipe to the siphon or trap through the valve.

13. The method of claim 12,
wherein if no heat demand is present, namely if heated water is not requested by the at least one water consumer, for a descaling of the heat exchanger the method comprises:
i) combusting gas with the gas burner at a defined burner load for a defined first time interval and provide the heated water to the siphon or trap, and
ii) stopping combustion of gas within the gas burner for a defined second time interval and provide the unheated water to the siphon or trap.

14. The method of claim 12,
wherein if no heat demand is present, namely if heated water is not requested by the at least one water consumer, for a descaling of the heat exchanger the method comprises:
i) combusting gas with the gas burner at a defined first burner load, preferably at a minimum burner load, for a defined first time interval and provide the heated water to the siphon or trap, and
ii) combusting gas with the gas burner at a defined second burner load, preferably at a maximum burner load, for a defined second time interval and provide the heated water to the siphon or trap, wherein the first burner load is relatively low compared to the second burner load.

15. The method of claim 13,
wherein during the first time interval and during the second time interval the water is provided from the output pipe to the siphon or trap through the valve.

16. The method of claim 14, wherein during the first time interval and during the second time interval the water is provided from the output pipe to the siphon or trap through the valve.
